(19) United States
(12) Patent Application Publication
(10) Pub. No.: US 2010/0010894 A1
(43) Pub. Date: Jan. 14, 2010

(54) SOFTWARE-AS-A-SERVICE AD CONTENT

(75) Inventor: John M. Boyer, Victoria (CA)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/168,996

(22) Filed: Jul. 8, 2008

(51) Int. Cl. G06Q 30/00

(52) U.S. Cl. 705/14.54; 705/7; 705/14.55

(57) ABSTRACT

Methods, systems and computer program products for providing software-as-a-service ad content. Exemplary embodiments include a software service ad content method, including providing a design module for creating the user interface and processing instructions for a dynamic document template, providing a deployment module configured to distribute the dynamic document template to a content repository, providing a retrieval module configured to retrieve the dynamic document template from the content repository, to instantiate a dynamic document from the dynamic document template, and to enable data entry into the dynamic document, and providing an ad content association module configured to select content to deliver with the retrieved dynamic document, wherein the selection comprises analysis of the content of the dynamic document.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Field

This invention relates to design and deployment of dynamic documents and associated advertisement content, and particularly to methods, systems and computer program products for providing software-as-a-service ad content.

2. Description of Background

Current search engines provide network (e.g., Internet) search services in which a user inputs search criteria. The search engine then returns search results. Typically, these search engines augment the search results with ad content. In addition, search engines include a revenue model which either monetizes the search service or, as is the case with a free search, monetizes the association of ad content with the parameters given to the service (the search terms). However, it is appreciated that this ad content is driven by the entity providing the search engine and the entities paying to place their ads with the search results. As such, a search is a specific service whose parameterization is, by happenstance, useful for identifying good ad content to associate with the returned results. In addition, a search is a special service whose result is essentially static (e.g., a set of search results contains links, not interactive user input controls).

### BRIEF SUMMARY

Exemplary embodiments include a software service ad content method, including providing a design module for creating the user interface and processing instructions for a dynamic document template, providing a deployment module configured to distribute the dynamic document template to a content repository, providing a retrieval module configured to retrieve the dynamic document template from the content repository, to instantiate a dynamic document from the dynamic document template, and to enable data entry into the dynamic document, and providing an ad content association module configured to select content to deliver with the retrieved dynamic document, wherein the selection comprises analysis of the content of the dynamic document.

Additional embodiments include a computer program product for providing software service ad content, the computer program product including instructions for causing a computer to implement a method, the method including providing a design module for creating the user interface and processing instructions for a dynamic document template, providing a deployment module configured to distribute the dynamic document template to a content repository, providing a retrieval module configured to retrieve the dynamic document template from the content repository, to instantiate a dynamic document from the dynamic document template, and to enable data entry into the dynamic document, and providing an ad content association module configured to select content to deliver with the retrieved dynamic document, wherein the selection comprises analysis of the content of the dynamic document.

Additional embodiments include a software service ad content system, including a server configured to provide advertisement content associated with dynamic documents, a design module provided by the server, the design module for creating the user interface and processing instructions for a dynamic document template, a deployment module configured to distribute the dynamic document template to a content repository, a retrieval module configured to retrieve the dynamic document template from the content repository, to instantiate a dynamic document from the dynamic document template, and to enable data entry into the dynamic document, and a submission module configured to enable submission and storage of the dynamic document.

Additional embodiments include a software service ad content method, including identifying a dynamic document template designed by a design module, identifying data entered into an instance of the dynamic document template subsequent to the design by the design module, instantiating a dynamic document from the dynamic document template and populating it with the data entered, and selecting associated advertisement content for the dynamic document, wherein the selection comprises analysis of the content of the dynamic document.

Further embodiments include a computer program product for providing software service ad content, the computer program product including instructions for causing a computer to implement a method, the method including identifying a dynamic document template designed by a design module, identifying data entered into an instance of the dynamic document template subsequent to the design by the design module, instantiating a dynamic document from the dynamic document template and populating it with the data entered, and selecting associated advertisement content for the dynamic document, wherein the selection comprises analysis of the content of the dynamic document.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### Technical Effects

As a result of the summarized invention, technically we have achieved a solution which has the ability to provide a generalized ad service, for which it may be the service result content rather than the service parameterization that more accurately determines appropriate ad content. In addition, the methods, systems and computer program products described herein handle the case of a generalized service whose initial results are dynamic documents used to actually provide part of the service's functionality. The methods, systems and computer program products described herein provide an alternative revenue stream for software-as-a-service offerings created by a software provider. Rather than monetizing a service based strictly on CPU usage, the association of ad content with content created during service usage is monetized.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for providing software-as-a-service ad content;

FIG. 2 illustrates a simplified block diagram illustrating the relationship and interaction between the users described in FIG. 1; and

FIG. 3 illustrates a flowchart of a method for providing software-as-a-service ad content in accordance with exemplary embodiments.

The detailed description explains the preferred embodiments of the invention, together with advantages and features, by way of example with reference to the drawings.

### DETAILED DESCRIPTION

Exemplary embodiments of the methods, systems and computer program products described herein associate advertisements with a system that allows “definition” and deployment of applications, where the advertisements can be based on the content created with the application. In exemplary embodiments, a designer using a form/workflow designing tool can create a set of rules associated to a point in a workflow. Those rules can query content from the workflows state in order to determine a set of keywords that are then used to tailor advertisements that decorate the application. In exemplary embodiments, the definition of the rules within the design tool as opposed to those rules being defined “hard coded” into a specific application. In exemplary embodiments, the advertisements can be based on the content created by a design tool user. In further exemplary embodiments, the advertisements can be based on the content created by an application user. In further exemplary embodiments, the advertisements can be based on the content created by a combination of the design tool user and the application user.

In exemplary embodiments, the methods, systems and computer program products described herein are a Web 2.0 concept in which the notion of application definition is democratized, (i.e. it is put in the hands of the users, not the enterprise.) In exemplary embodiments, the enterprise offers end-users the ability to design and deploy their own web applications. Rather than offering a software as a service (SaaS), the enterprise offers the ability to “design and deploy” a SaaS. As such, the enterprise can then dynamically create the association between advertisements and web applications by introspecting the web application definition provided by type A users (designers) as well as data provided by type B user (fillers) in order to determine the most relevant advertisements to present.

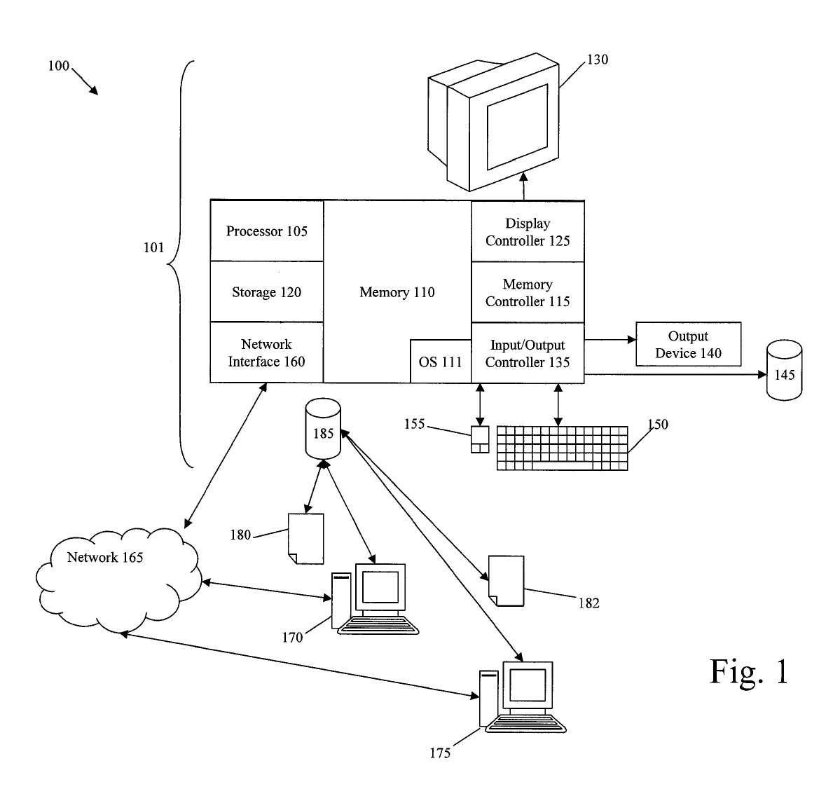

FIG. 1 illustrates an exemplary embodiment of a system 100 for providing software-as-a-service ad content. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the ad content methods described herein in accordance with exemplary embodiments and a suitable operating system (OS) 111. The operating system 111 essentially controls the execution of other computer programs, such the ad content systems and methods described herein, and provides scheduling, input-output control, file and data management, memory management, and communication control and related services.

The ad content methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the ad content methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The ad content methods described herein and the OS 111, in whole or in part, but typically the latter, are read by the processor 105, perhaps buffered within the processor 105, and then executed.

When the systems and methods described herein are implemented in software, as is shown in FIG. 1, the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The ad content methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the ad content methods are implemented in hardware, the ad content methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In exemplary embodiments, the system 100 can include one or more end user computers 170, 175 configured to receive a dynamic document 182 from the computer 101. As further described herein, the dynamic document 182 is delivered with associated advertisement content dependent on input from users of the computers 101, 170, 175.

In exemplary embodiments, the computer 101 is a SaaS provider, an enterprise that provides computing power and computer storage necessary to execute software services. In exemplary embodiments, the computer 101 can provide computing power via software to one or more end computers 170, 175. In exemplary embodiments, the computer 170 can receive a design user interface and processing instructions that enable a user of the computer 170 to create a dynamic document template 180 (i.e., dynamic document) via the design user interface. The software provided by the computer 101 can also include a deployment module that enables the user of the computer 170 to distribute the dynamic document template indirectly to users of the computer 175. In exemplary embodiments, the computer 101 can further provide storage 185 (i.e. a content repository) into which the user of the computer 170 can deposit the dynamic document template 180. In exemplary embodiments, the software provided by the computer 101 can further include a retrieval module that can be invoked by users of the computer 175 to retrieve the dynamic document template 180 from the storage 185. The software provided by the computer 101 can further enable users of the computer 175 to instantiate a dynamic document 182 from the template and enter data into the dynamic document.

In exemplary embodiments, the user of the computer 170 is a Type A user that determines the design of the dynamic document template 180 and is thus provided a design experience from the computer 101. The users of the computer 175 are Type B users who enter data into the dynamic document 182 instantiated from the dynamic document template 180. In exemplary embodiments, advertisements can adorn the dynamic document 182 based on a set of rules, which can include providing advertisements for Type B users' experiences. As such, in exemplary embodiments, the computer 101 further provides advertisement content associated with a dynamic document 182 based on either or both on how the dynamic document template 180 is designed by the Type A user during the design experience and further based on information and data provided by the Type B user(s) during their fill experience of a dynamic document 182 instantiated from dynamic document template 180. It is therefore appreciated that the storage 185 can include many instances of the dynamic document template 180 to track multiple states of the dynamic document template 180, the states determining the advertisement content that is associated with the dynamic document 182. In exemplary embodiments, the enterprise associated with the computer 101 can bill each time advertisements are associated and delivered with a dynamic document 182. As such, the enterprise can provide this type of software service to associate advertisement content requested by the various end users in the system 100.

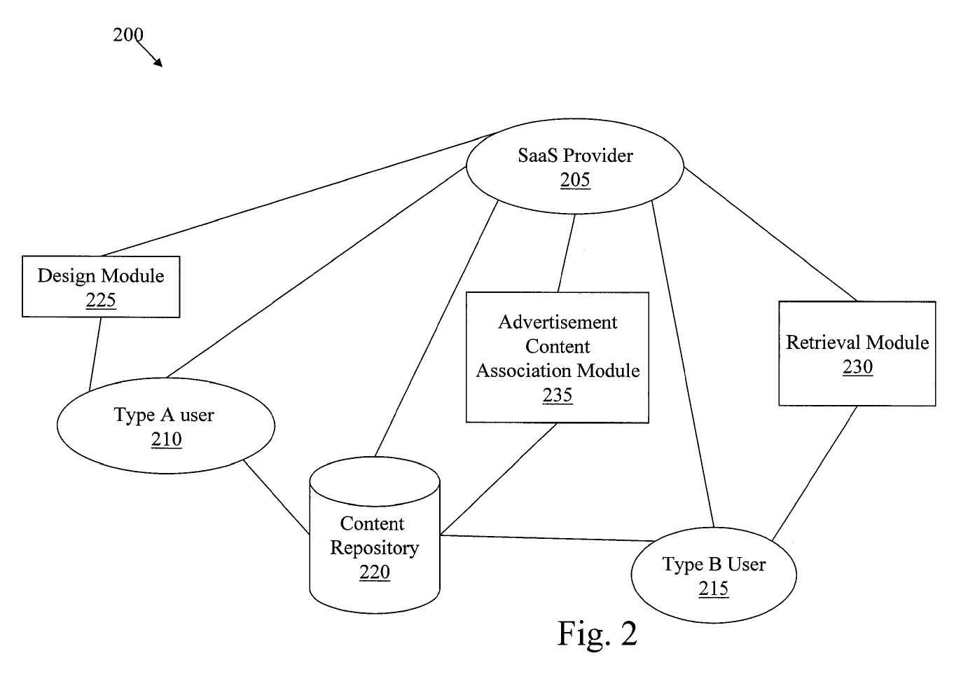

FIG. 2 illustrates a simplified block diagram of a system 200 illustrating the relationship and interaction between the users described in FIG. 1. The system includes the SaaS provider 205 as described herein. The system 200 further includes a Type A user 210. The system 200 further includes one or more Type B users 215 (one illustrated). The system 200 further includes a content repository 220 provided by the SaaS provider 205. In exemplary embodiments, the SaaS provider further provides a user interface and processing instructions for dynamic document template design software illustrated as a design module 225. Similarly, the SaaS provider 205 provides a retrieval module 230 to the Type B users. The retrieval module 230 provides the Type B users with the ability (i.e., software and computing power) to instantiate a dynamic document from a dynamic document template created by the Type A user 210 and enter data into the instantiated dynamic document. In exemplary embodiments, once the Type A user 210 has created the dynamic document template, the Type A user 210 can deposit the dynamic document template into the content repository 220, from which the Type B users 215 can retrieve the dynamic document template when it is time for the Type B users 215 to instantiate a dynamic document from the dynamic document template and fill data into the dynamic document. Once the Type B user enter data into the dynamic document, the Type B user returns the dynamic document to the content repository 220. It is therefore appreciated that the content repository 220 can include several instances of the dynamic document template. In exemplary embodiments, the SaaS provider further provides advertisement content along with the dynamic documents obtained with Retrieval Module 230, via providing an advertisement content association module 235. In exemplary embodiments, once the Type A user 210 has designed the template, the content that the Type A user 210 has added to the dynamic document template is one factor that determines the advertisement content that can be associated with instances of the dynamic document template. Similarly, once the Type B users 215 have added content to (i.e. entered data into) a dynamic document, the content added by the Type B users 215 can further determine the type of advertisement content that the SaaS provider 205 associates with the dynamic document. In addition, there can also be multiple classes of Type B users that provide additional content to the dynamic document template. It is appreciated that the content provided by the multiple Type B users 215 can all be used by the SaaS provider to determine the advertisement content to be associated with multiple instances of the dynamic document template.

In exemplary embodiments, as described above, the methods, systems and computer program products described herein provide a generalized ad service, for which it may be the service result content rather than the service parameterization that accurately determines appropriate ad content. In addition, the methods, systems and computer program products described herein handle the case of a generalized service whose initial results are dynamic documents used to actually provide part of the service's functionality. In exemplary embodiments, a dynamic document is an empty template document or a partially completed document that is provided to an end-user for the purpose of having that end-user complete and return the document or at least to add/modify/delete content and return the document to the service for continued operation in a workflow provided by the service. In exemplary embodiments, when the user fills in a blank on a form, the user is adding content to the form. As such, the prior form is empty and now contains text content that the user added. If the document contains the right declarations, the document can enable the user to press buttons that add rows of data that are presented by a table. When a row of data is added, the user can interact with the corresponding user interface elements for that data to then add text content. As such, both structural content and text content can be added. In exemplary embodiments, the user can also delete structure and text content. In exemplary embodiments, the user can press a “delete” button to remove a row of data and associated user interface elements from a table, or the user could simply use the delete key to remove text content only from a non-empty data field.

In exemplary embodiments, a dynamic document may also be an intelligent document that internally contains behavioral rules as well as information on how to submit the document back to the service. As described above, a “dynamic document” is a document that allows a user to type data values, or add/delete structural content as well as data values. As such a dynamic document can include a document format like basic HTML, which can also submit the resulting data content to a server. In exemplary embodiments, an “intelligent” document is one that can include additional declarative rules that automatically respond to user interactions by calculating values (e.g. a purchase order subtotal, tax and total), calculating properties (e.g., whether parts of the user interface and data are relevant based on conditions), or calculating data validity (e.g., a journal article print request must not have a higher page number less than the lower page number). An intelligent document may also include the ability to send the entire document, not just the data, back from the client-side to the server-side.

In exemplary embodiments, the end-user calls upon the service to request a document that can be filled in to initiate, continue or complete a business function of interest to the end-user. The software service provides the document and the business function to the end-user in order to also be able to provide the ad content to the end-user. The selection of ad content is based on the content of the document returned, the metadata associated with that document, or the state of the business function that provides the document. In exemplary embodiments, the generation of advertisement content is enabled from advertisement generation methods known in the art. In exemplary embodiments, the SaaS provider is creating a system in which Type A users define applications that type B users can implement because the SaaS provider seeks to associate advertisements with the applications provided to type B users. In addition, Type A users can also be Type B users as further described below.

For example, the system may be a vacation or “leave request” system. An office administrator, who is a Type A user in this instance, would like to be able to coordinate the vacation and leave schedules of employees to ensure adequate coverage during the main vacation seasons. The office administrator would create the vacation request form to be filled out by individual employees and then approved by their managers after consulting the common schedule. The software service (e.g., the SaaS provider) would provide the ability to define employees and their managers, the ability to submit a vacation request, the ability view approved vacations, and the ability to approve or reject a vacation request. As described above, the pattern in the leave request system is a SaaS design and deployment system in which the SaaS content is decorated by advertisements according to rules defined by the SaaS provider.

When the vacation request form is obtained by an employee, for example (in this case a Type B user), if the vacation request form is empty, then appropriate ad content might consist of advertisements for popular vacation destinations and resorts, airline discounts, car rentals and so forth, now viewable by the employee. For example, an initial empty document may request that the user enter the start and end dates of the vacation. The empty template document still has the word “vacation” in it, which allows the SaaS provider to decide to show ads for rental cars, hotels, and hot destinations. As the user fills out the form with dates, the system can use Ajax, for example, to update the ads with special deal ads that depend on information filled by the end-user. Once the end-user submits the vacation request document for approval, the next end-user would be the manager of the employee. When the manager requests the vacation document, the document's advertisement content is not empty and appropriate advertisement content might include of advertisements for temp agencies, contractors, or employment agencies associated with the expertise of the employee whose vacation or leave is being considered. It is appreciated that when each end user sends the modified dynamic document to a subsequent end user, the methods, systems and computer products described herein (i.e., via the SaaS provider, for example) determine what rules are added to detect keywords and other indicators in the request and approval states, for example, such that other advertisement content can be associated with the dynamic document. In exemplary embodiments, Type A users can also be Type B users. For example, the Office Administrator, designated as a Type A user, may also retrieve and instantiate the vacation request form with the adorned vacation advertisements and be able to take advantage of those vacation advertisements. It is appreciated that the SaaS provider provides the computing power to both Type A and Type B users to perform respective operations. For example, The SaaS provider provides the ability to the Office Administrator in the above example to create a vacation request system having a vacation request (dynamic) document with all of the necessary data fields to be filled by employees. In addition, the SaaS provider provides the computing power enabling the Type B user (e.g., the employee requesting the vacation) to fill out the necessary fields provided by the Office Administrator. It is further appreciated that the SaaS provider is the entity that provides the rules that determine the advertisement content that is adorned to the dynamic document as it is designed, deployed and filled out. The rules detect patterns and keywords in the document created by the vacation request system (or other system generated by the Type A user). For example, the pattern that can be detected by the SaaS provided rules are the states of the document (e.g., whether the document is in a request state or in an approval state, which further determines which end user has possession of the document, which determines the type of advertisements that are adorned in the document). In exemplary embodiments, the document can include several “instances”, which represent the different states of the document as it is passed among users. Ultimately, the document can be stored either as a completed document (i.e., including all fill information from the various end users), or it can be stored as an originally empty document with pointers pointing to the data representing the different instances/states of the document.

As such, the purpose of a software service, or the effect it achieves, is called the business function. The Type A user has an intention, like tracking vacations and leave requests of type B users. The software service implements the business function. The type A user decides on the particulars of the business function and implements them using the tools available. The SaaS provider above needs to provide a document template design tool that allows the type A user to specify part of the implementation of their business functions. The document template defines the type B end-user fill experience. Other tools from the SaaS provider can allow the type A user to specify under what conditions various type B users could gain access to the documents created and partially or wholly filled by other type B users, thus achieving basic workflow. More tools could be provided to allow simple listing and reporting capabilities via queries from the Type A user.

As described above, conventional search services provide advertisement content to returned search results based on parameterization. As such, with a conventional search, the user enters the keywords and ads that are returned are based on the keywords and not on the returned content. It is appreciated that the exemplary methods, systems and computer program products described herein provide several differences to conventional search service. In exemplary embodiments, a user makes a request to the software service for a document that initiates, continues or completes a business function. The document is then returned to the user in response to the request and the request for the software service for the document determines the selection of the advertisement content. As such, the advertisements are based on the content of the document when it is returned and/or more content that the user types while interacting with the document. By comparison, it is conventionally the parameters of a search request that determine the selection of the advertisement content, and the results of the search do not further participate in the business function of the search service, so there is no opportunity to associate advertisement content with the search results or the user's interaction with the search results.

In exemplary embodiments, the document provided by the software service is a dynamic entity that is capable of collecting information needed to drive a back-end business function. In exemplary embodiments, the dynamic document includes the ability to receive content added by end users and to have content automatically added. In exemplary embodiments, the document can present user interface controls that enable the user to type content that the document collects to drive a back-end function. A Type A user defines what information must be collected by the application, then requests that the SaaS provider deploy the application (i.e., make it available to Type B users). The application then sends documents to the Type B users and the document then collects information from the Type B users. In exemplary embodiments, the dynamic/intelligent nature of the document enables the document to invoke web services during the Type B user's fill experience to obtain related data that simplifies the fill experience. It is appreciated that the documents collect data directly from end-users who type the data, or press the add/delete row buttons (or other input mechanisms). In contrast, conventional search services provide static search results and the service ends after providing the search results. In exemplary embodiments, the software service does not end with providing the document. Because the software service provides a full business function, it is possible for the business function to be in more than one state when the document is provided to the end-user. (It is appreciated that a business function can include any function that a business desires to perform (e.g., keeping track of who is going on leave or the types of orders being received, delivery times of products and pricing)).

In exemplary embodiments, different states of the document depend on the content that has been added by different end users. For example, a leave request might be in the state of initial request, or a first Type B user might submit it to the server, where the act of submission changes it to the second state of “approval needed”, which would change the advertisements one might reasonably see. Once approval is granted, a third state is created by an act of the second Type B user, which then causes the document to be relevant to at least the first end user, but also possibly by an additional end user (e.g., the HR manager, who might have to take special actions for a maternity or paternity leave). It is appreciated that the advertisement content can be selected based on the state of the business function, which may be maintained by the software service or stored in the document.

In exemplary embodiments the software service, which is subsequently identified and selected by a user, is defined by a software provider and can include several components. In exemplary embodiments, the software components can include, but are not limited to: 1) a business function including a set of states; and 2) a set of documents that collect information for the business function.

In exemplary embodiments, the software service provider defines a set of advertisement content rules. In exemplary embodiments, these rules can select advertisement content based on criteria including but not limited to: 1) type of document delivered by the service; 2) content of document delivered by the service; and 3) state information from the business function. In exemplary the rules select advertisements dependent on the initial content of the document and subsequently dependent on each end user, via typing text into fields, selecting drop-down lists, clicking check boxes, pressing buttons and other actions in which the end user add content.

In exemplary embodiments, once the software service (and documents) is exposed to end-users, any request for a document from the service can result in provisioning both the document and advertisement content obtained by applying the selection rules to at least one of the return document and the business function state information.

In exemplary embodiments, associating metadata with each document may be considered as just a special form of advertisement content rule as defined above. For example, the system may allow search terms to be associated with each type of document in the set of documents. In this case, the advertisement content rule would simply select advertisement content based on the terms associated with the document being delivered.

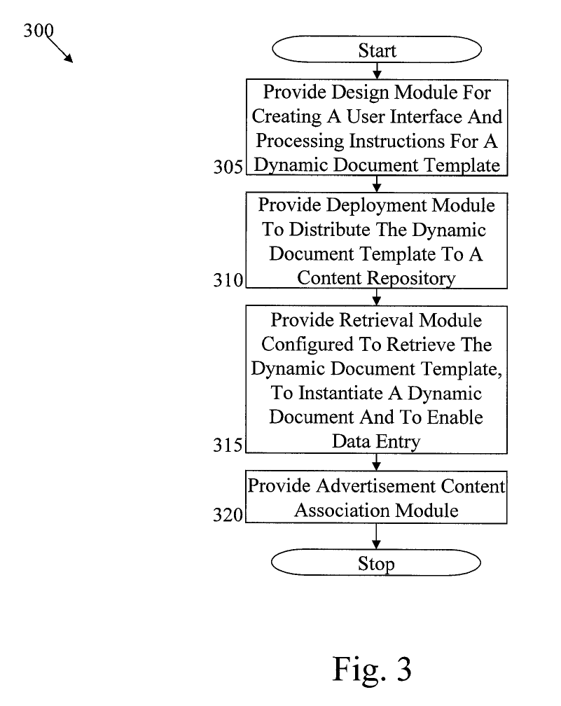

FIG. 3 illustrates a flowchart of a method 300 for providing software-as-a-service ad content in accordance with exemplary embodiments. At block 305, the SaaS provider provides a design module for creating a user interface and processing instructions for a dynamic document template. At block 310, the SaaS provider further provides a deployment module configured to distribute the dynamic document template to a content repository. At block 315, the SaaS provider provides a retrieval module configured to retrieve the dynamic document template from the content repository, to instantiate a dynamic document from the dynamic document template, and to enable data entry into the dynamic document. At block 320, the SaaS provider provides an ad content association module configured to select content to deliver with the retrieved dynamic document, wherein the selection comprises analysis of the content of the dynamic document. In exemplary embodiments, the SaaS provider of method 300 can further provide a dynamic document submission module enabling the server to receive a dynamic document with data entered, store it in the content repository, and later receive a request to retrieve the dynamic document from the content repository and provide the dynamic document along with the advertisement content determined based on the data entry. In addition, a state of a business function can be derived from the dynamic document stored in the content repository, and advertisements can be associated and delivered with the dynamic document based on a predetermined set of rules. For example, the advertisement content can be provided based on a type of the dynamic document template, the content of the dynamic document template or state information from one or more business functions.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

As described above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A software service ad content method, comprising:
providing a design module configured to create a user interface and processing instructions for a dynamic document template;
providing a deployment module configured to distribute the dynamic document template to a content repository;
providing a retrieval module configured to retrieve the dynamic document template from the content repository, to instantiate a dynamic document from the dynamic document template, and to enable data entry into the dynamic document; and
providing an advertisement content association module configured to select content to deliver with the retrieved dynamic document, wherein the selection comprises analyzing the content of the dynamic document.

2. The method as claimed in claim 1 wherein the selection of associated ad content comprises analyzing the dynamic document template portion of the dynamic document.

3. The method as claimed in claim 1 further comprising providing a submission module configured to enable submission and storage of the dynamic document in the content repository.

4. The method as claimed in claim 3 wherein the retrieval module is further configured to retrieve a dynamic document from the content repository.

5. The method as claimed in claim 4, wherein the advertisement content is selected based on the data entered in the dynamic document.

6. The method as claimed in claim 4 wherein a state of a business function is derived from a dynamic document stored in the content repository and wherein associated ad content for the dynamic document is selected based on a state of one or more business functions that are associated with the dynamic document template.

7. The method as claimed in claim 4 wherein the advertisement content is selected based on metadata for the dynamic document template.

8. A computer program product for providing software service ad content, the computer program product including instructions for causing a computer to implement a method, the method comprising:
providing a design module configured to create a user interface and processing instructions for a dynamic document template;
providing a deployment module configured to distribute the dynamic document template to a content repository;
providing a retrieval module configured to retrieve the dynamic document template from the content repository, to instantiate a dynamic document from the dynamic document template, and to enable data entry into the dynamic document; and
providing an ad content association module configured to select content to deliver with the retrieved dynamic document, wherein the selection comprises analyzing the content of the dynamic document.

9. The computer program product as claimed in claim 8 wherein the selection of associated ad content comprises analyzing the dynamic document template portion of the dynamic document.

10. The computer program product as claimed in claim 8 wherein the method further comprises providing a submission module configured to enable submission and storage of the dynamic document in the content repository.

11. The computer program product as claimed in claim 10 wherein the retrieval module is further enabled to retrieve a dynamic document from the content repository.

12. The computer program product as claimed in claim 11, wherein the advertisement content is selected based on the data entered in the dynamic document.

13. The computer program product as claimed in claim 11 wherein a state of a business function is derived from a dynamic document stored in the content repository and wherein associated ad content for the dynamic document is selected based on a state of one or more business functions that are associated with the dynamic document template.

14. The computer program product as claimed in claim 11 wherein the advertisement content is selected based on metadata for the dynamic document template.

15. A software service ad content system, comprising:
a server;
a design module provided by the server, the design module configured to create a user interface and processing instructions for a dynamic document template;
a deployment module configured to distribute the dynamic document template to a content repository;
a retrieval module configured to retrieve the dynamic document template from the content repository, to instantiate a dynamic document from the dynamic document template, and to enable data entry into the dynamic document; and
wherein the server is configured to provide advertisement content and the dynamic document.

16. The system as claimed in claim 15 wherein the selection of associated ad content includes an analysis of the dynamic document template portion of the dynamic document.

17. The system as claimed in claim 15 further comprising providing a submission module configured to enable submission and storage of the dynamic document in the content repository.

18. The system as claimed in claim 17 wherein the server is configured to provide a dynamic document along with the associated ad content determined based on the data entry.

19. The system as claimed in claim 17 wherein a state of a business function is derived from a dynamic document stored in the content repository and wherein associated ad content for a dynamic document is selected based on a state of one or more business functions that are associated with the dynamic document template.

20. A software service ad content method, comprising:
identifying a dynamic document template designed by a design module;
retrieving from a content repository data entered into an instance of the dynamic document template subsequent to the design by the design module;
instantiating a dynamic document from the dynamic document template and populating the dynamic document with the data entered;
enabling data entry into the dynamic document; and
selecting associated advertisement content for the dynamic document, wherein the selection comprises analysis of the content of the dynamic document.

21. The method as claimed in claim 20 further comprising providing a submission module configured to enable submission and storage of the data entry in the content repository.

22. The method as claimed in claim 20 wherein a state of a business function is derived from a dynamic document stored in a content repository and wherein associated ad content for the dynamic document is selected based on a state of one or more business functions that are associated with the dynamic document template.

23. A computer program product for providing software service ad content, the computer program product including instructions for causing a computer to implement a method, the method comprising:
identifying a dynamic document template designed by a design module;
retrieving from a content repository data entered into an instance of the dynamic document template subsequent to the design by the design module;
instantiating a dynamic document from the dynamic document template and populating the dynamic document with the data entered;
enabling data entry into the dynamic document; and
selecting associated advertisement content for the dynamic document, wherein the selection comprises analysis of the content of the dynamic document.

24. The computer program product as claimed in claim 23 wherein the method further comprises providing a submission module configured to enable submission and storage of the data entry in the content repository.

25. The computer program product as claimed in claim 23 wherein a state of a business function is derived from a dynamic document stored in a content repository and wherein associated ad content for the dynamic document is selected based on a state of one or more business functions that are associated with the dynamic document template.
